(19) United States
(12) Patent Application Publication
(10) Pub. No.: US 2002/0032691 A1
(43) Pub. Date: Mar. 14, 2002

(54) High performance efficient subsystem for data object storage

(75) Inventors: Faramarz Rabii, Somerville, MA (US); Richard J. Morris, Newton, MA (US)

Correspondence Address: David J. Thibodeau, Jr., HAMILTON, BROOK,, SMITH & REYNOLDS, P.C., Two Militia Drive, Lexington, MA, 02421-4799, US

(73) Assignee: InfoLibria, Inc., Waltham, MA

(21) Appl. No.: 09/866,383

(22) Filed: May 25, 2001

Related U.S. Application Data
(60) Provisional application No. 60/207,995, filed on May 26, 2000.

(51) Int. Cl. G06F 12/00; G06F 17/30

(52) U.S. Cl. 707/200

(57) ABSTRACT

A non-hierarchical or linear directory structure for a mass storage unit such as a disk. The directory structure can be kept in an auxiliary semiconductor memory. The disk is partitioned into segments of equal size. The directory structure presumes that data objects reside wholly and contiguously within a given area of the disk segments. While a variable number of objects may be stored within each segment, a given object is not allowed to occupy more than one segment. During a storage operation, objects are assigned to segments in a round-robin fashion, to equalize segment utilization.

### RELATED APPLICATION(S)

This application claims the benefit of U.S. Provisional Application No. 60/207,995, filed on May 26, 2000, the entire teachings of which are incorporated herein by reference.

### BACKGROUND OF THE INVENTION

The present invention relates to a data storage subsystem and more particularly to a disk file structure that provides efficient overhead operations such as garbage collection and fault recovery.

Many modern data processing systems include one or more subsystems that are responsible for data storage and retrieval. Such systems often use different types of storage devices and media. Device types for specific applications are chosen depending upon how specific attributes can best be exploited. For example, magnetic hard disks are most often employed to provide an inexpensive mass storage medium. However, the access time of disk devices is rather slow compared to the speed of computer processors. This is because hard disks typically reply on the movement of mechanical assemblies to retrieve or store data.

On the other hand, electronic devices such as semiconductor Random Access Memories (RAMs) are often employed in storage applications that require high performance. These devices are particularly fast because they operate on a purely electronic basis. Unfortunately, semiconductor memories are often limited in size, suffer from volatility (they lose their contents when power is removed), and cost constraints. Applications requiring excessive amounts of storage typically employ hard disks because they are far less expensive and more reliable. Electronic devices also typically require a greater physical area in which to achieve an equivalent storage capacity, and require complex electronic packaging technologies. Both types of devices are invariably used in data processing systems with disk storage used as a bulk device. Data needed is then read from the disk and copied to a semiconductor RAM for further high speed data processing. Once processing is completed, the data is then written back to the disk.

A number of data processing applications must determine whether a particular data file or, more precisely, any given data object, exists in disk structure prior to fetching it. Such a task becomes tedious when the number of object entries or files on the disk is rather large. For example, some disks contain hundreds of thousands, if not millions, of files, any of which must be retrieved in short order. As a result, techniques have been developed to expedite the retrieval of disk files.

Due to the widespread deployment of Internet infrastructure, one emerging application for high performance data retrieval subsystems is Web servers. Such Web servers provide storage for thousands of unique Web pages, the bulk of which are requested on a continuous basis throughout the day. To keep up with the often relentless demand, it is critical that a page retrieval process uses optimized methods for determining the location of requested objects.

Such servers can be employed as a primary Web server providing storage for source documents, such as Web pages and other data objects, to which requests are made. However, other servers, so-called intermediate cache servers, are employed along the routes or paths between network nodes. Such cache servers provide the opportunity for a request for a document to be intercepted and served from such intermediate node locations. This overall network architecture speeds up the delivery of requested content to end users.

### SUMMARY OF THE INVENTION

For optimum performance of data object servers such as Web page and/or cache servers, certain recognition should be given to the characteristics of typical data objects in the Web environment. For example, Web objects are typically written once. Afterwards, they are then read many, many times before they are modified again. Thus, read efficiency is far more important than write efficiency in the context of the Web.

In other instances, certain objects are expected to expire, i.e., be deleted, at known times. For example, a Web site which is carrying news content will typically maintain articles for only a certain number of days.

Disk subsystems used in Web servers must also be capable of quick initial startup and/or recovery from crashes. During such startup and/or down times, access to the disk is denied to users who are connected to the Web server. In the case where the server is a cache server, access to the entire network may be denied.

In addition, garbage collection and other storage efficiency routines should be carried out in a way which consumes as little time as possible, without using otherwise important resources that should be dedicated to servicing user requests.

The present invention seeks to alleviate these and other difficulties by providing a non-hierarchical or linear directory structure for a mass storage unit such as a disk. The directory structure can be kept in an auxiliary semiconductor memory. The disk is partitioned into segments of equal size. The directory structure presumes that data objects reside wholly and contiguously within a given area of the disk segments. While a variable number of objects may be stored within each segment, a given object is not allowed to occupy more than one segment. During a storage operation, objects are assigned to segments in a round-robin fashion, to equalize segment utilization.

Also employed is a specific data object naming criteria. Any hierarchical object identifier such as a uniform resource locator (URL) or directory/filename specifier is first hashed into at least two binary numbers, including a first number and a second number. The number of bits in the first number is selected to correspond to a number of tables for a segment. The second number is then read as an index into a specific directory table that contains location information for a particular object. The invention therefore provides a flat, non-hierarchical directory structure which allows object lookups in a predictable, fixed amount of time, even though such objects may have been originally specified as being hierarchical. This is because all objects are resident in only one segment, and are stored contiguously, and because they can be located with two short table lookups.

The invention implements only the file system interfaces needed for high performance data structure. For example, unlike other directory structures, the inventive structure need not be modifiable since it is formatted as a preset mathematical construct.

The invention also supports a very low overhead garbage collection mechanism that does not require disk access.

All disk structure meta data, such as the directory structure which specifies a location of each object, can be maintained in a high speed memory device during run time. A mirror image of the meta data may be periodically flushed to a dedicated file partition on the disk. As such, after a crash, there is no need to run a file seek or other cache recovery processes prior to restarting the disk to restructure the directory.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram of a network system in which a storage device according to the invention may be employed.

FIG. 2 is a high level diagram of meta data and object data partitions formed on the disk.

FIG. 3 shows a meta data partition in more detail.

FIG. 4 shows a superblock meta data portion in more detail.

FIG. 5 is a somewhat detailed view of a data partition.

FIG. 6 is a more detailed view of a data object.

FIG. 7 illustrates the structure of a directory.

FIG. 8 shows a more detailed view of a directory block.

FIG. 9 is a more detailed view of a superblock, specifically a segment table portion for a partition.

FIG. 10 illustrates data structures that may be involved in accessing an open object.

### DETAILED DESCRIPTION OF A PREFERRED EMBODIMENT

A description of preferred embodiments of the invention follows.

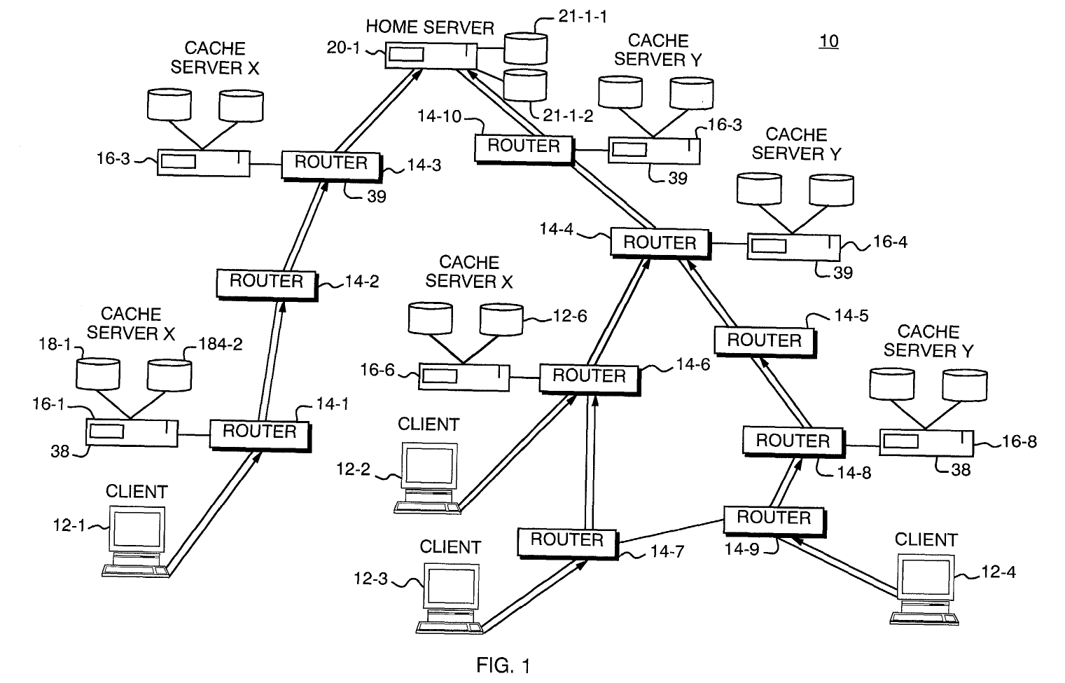

Turning attention now to FIG. 1 a computer network 10, such as the Internet, extranet, private intranet, virtual private network, local area network, or other type of computer network consists of a number of data processing entities, including client computers 12-1, 12-2, 12-3, . . . , 12-4 (collectively “the clients 12”), routers 14-1, 14-2, . . . , 14-10, Web cache servers 16-1, 16-3, 16-4, . . . and Web home servers 20. The network 10 may make use of various types of physical layer signal transmission media, such as public and private telephone wires, microwave links, cellular and wireless, satellite links, and other types of data transmission techniques.

In the illustrated network, both the Web home servers 20 and the Web cache servers 16 provide for storage for documents or other data objects in the form of mass storage devices 18 and 21. Cache servers 16 are associated with cache mass storage 18 which may include disk storage 18-1-1 and memory storage 18-1-2. Similarly, the home server 20 has associated disk storage 21-1-1 and memory storage 21-1-2.

It is assumed in the following discussion that the network 10 is the Internet, that information is stored at the servers 16 and 20 is the in form of Web data objects such as hypertext transfer protocol (HTTP) documents and that request messages are routed among the computers in order to fetch the documents by references such as in the form of uniform resource locator (URL) using standard network protocol such as the transmission control protocol/Internet protocol (TCP/IP). However, this one example is described with the understanding that many other types of computer architectures, network architectures, and other types of data objects and/or protocols may make advantageous use of the teachings of the present invention.

In any event, in such a network 10, document requests originate typically at one of the client computers such as client 12-1 in the form of URLs specification for an HTTP document stored at a home server 20. The message is formulated as a request by the client in the HTTP protocol for the homer server 20 to return a copy of a data object that is presently stored at the home server 20, such as a file stored on the disk 21-1. The document request is passed through one or more routers 14, such as routers 14-1, 14-2, 14-3, in the direction of the illustrated arrows, on its way towards the home server 20. The request may be intercepted at any of the intermediate nodes that have a cache server 16 are associated with them. Cache servers 16 intercept document requests and determine if the requested data object can be served from one of its local disks 18. In particular, if the requested data object is stored on one of the disks 18 associated with one of the cache servers 16, the requested content will instead be delivered from the cache server 18 rather than the home server 20.

The exact manner of interception of document requests by the cache servers 18 is not a particular consequence to the present invention. This may be done by directly having the cache servers 18 cooperate with the home server 20 when such requests are made by intercepting such requests through the use of reprogramming of domain name services (DNS), sending out probing messages in search of copies throughout the network 10, or in myriad other ways.

What is important to note with respect to the present invention is that both the cache servers 16 and home servers 20 are, in effect, storage subsystems that are responsible for maintaining extremely large numbers of data objects and providing copies of them as efficiently as possible when requested.

The mass storage devices 18 or 21 associated with the servers 16 or 20 contain a very large data store such as a hard disk that is capable of storing a potentially enormous set of object files. Each server 16 or 20 also typically makes use of a second memory device such as a random access memory (RAM) in which to store directory table information incorporating a logical map of object specifiers and their corresponding object locations in the mass storage device.

Although the data objects are specified using a hierarchical nomenclature such as a Uniform Resource Locator (URL), the directory structure used is not itself hierarchical. This provides a great advantage, especially for the cache server 20. In the present invention, an object specifier for a requested object, such as in the form of the URL, is first converted or hashed to a predetermined but unique set of data bits. These bits are then used to locate a corresponding target object in the corresponding mass storage device. As will be understood in further detail below, this permits lookup in an efficient fashion such as by using a first part of data bits to specify one of a set of lists or directory tables. The second portion of the bits can correspond to a particular entry in the table. Once the corresponding link list entry is determined, the corresponding target object address location associated with the requested object is then easily retrieved from the mass storage device.

Traditional disk structures for storing Web objects identified by Uniform Resource Locators (URLs) have multiple, hierarchical directory or folder names followed by a filename. But consider the case of the cache server 20 which is supporting many users' access to thousands of Web sites. As such, if it simply stores objects by their hierarchical URL, an extremely deep hierarchical directory structure results, with lots of levels and lots of overhead to locate objects. As will be understood shortly, the invention greatly enhances not only the efficiency at which objects can be retrieved, but also simplifies the directory structures maintained in the meta data portion 100.

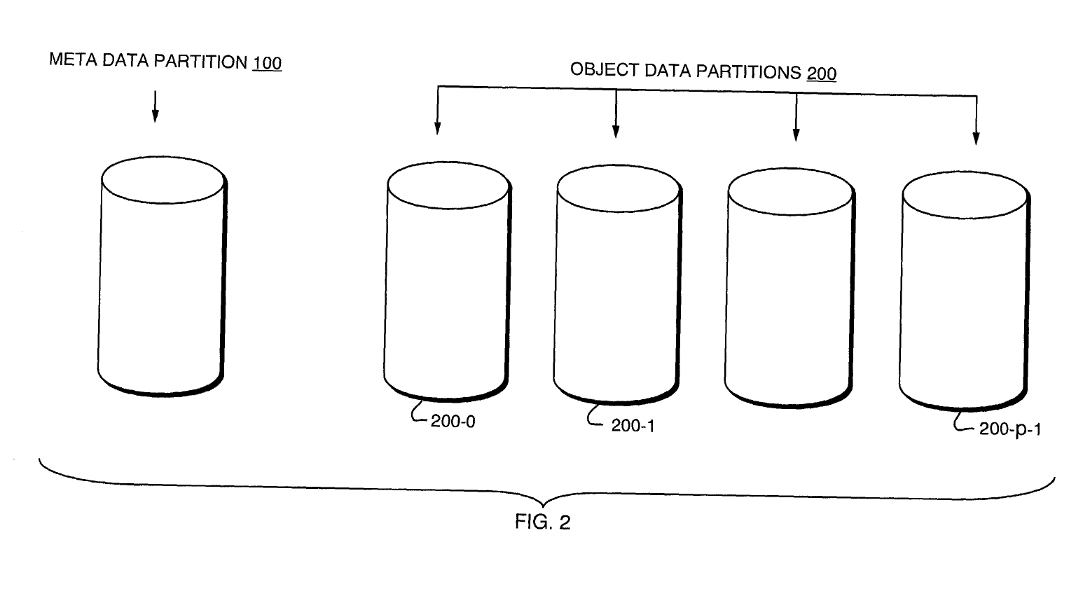

A very high level view of an overall layout strategy for the mass storage device 18 or 21 is shown in FIG. 2. Areas of the disk (the mass storage is assumed to be a disk) can be divided into two major types. “Object data” is the source information that contains end user requests that is, for example, specified by a URL. Such object data are stored in object data partitions 200. But one or more of the portions on the disk are also dedicated to being meta data partitions 200. These meta data partitions 200 contain information about the structure of the overall disk subsystem.

In a preferred embodiment, each object data partition 200 is divided into a set of equal size segments. For example, with a 9 gigabyte (GB) partition size and 128 segments, each segment would contain 72 megabytes (MB). In a preferred embodiment, the 72 MB segment size is designed to be at least a factor of two larger than the largest expected object that is expected to be stored. This is due to the requirement that each data object must reside wholly within one segment, and no object is allowed to span segments.

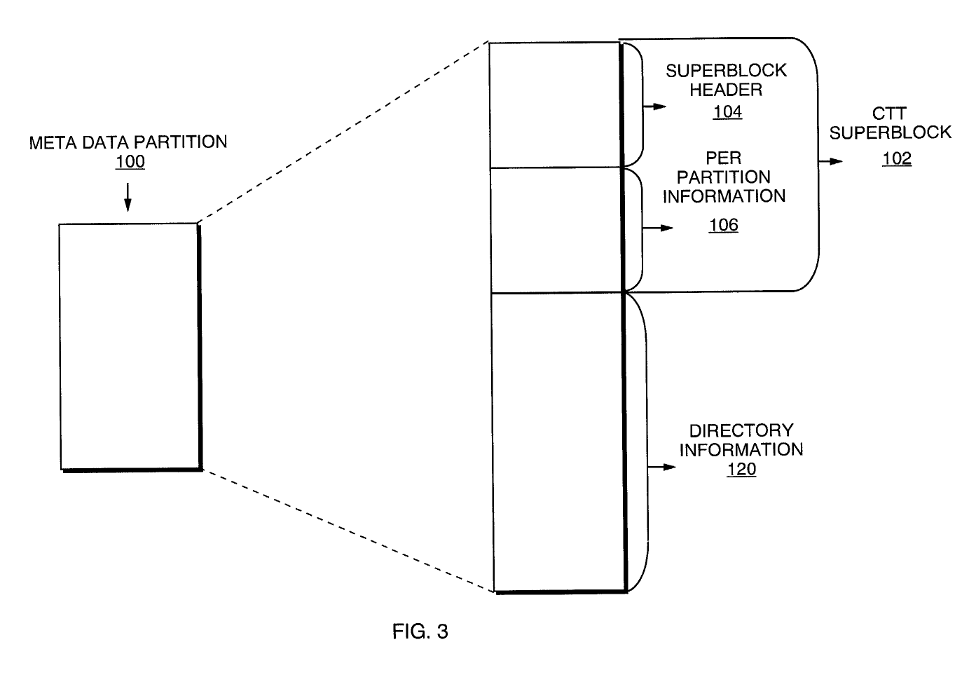

FIG. 3 is a more detailed diagram of the information stored in the meta data portion 100. Meta data partition 100 contains two types of information. The first type, called a superblock 102, describes general disk structure information such as the number of data partitions 200 and the maximum number of data objects that may be handled. This general structure information may be stored in a superblock header 104.

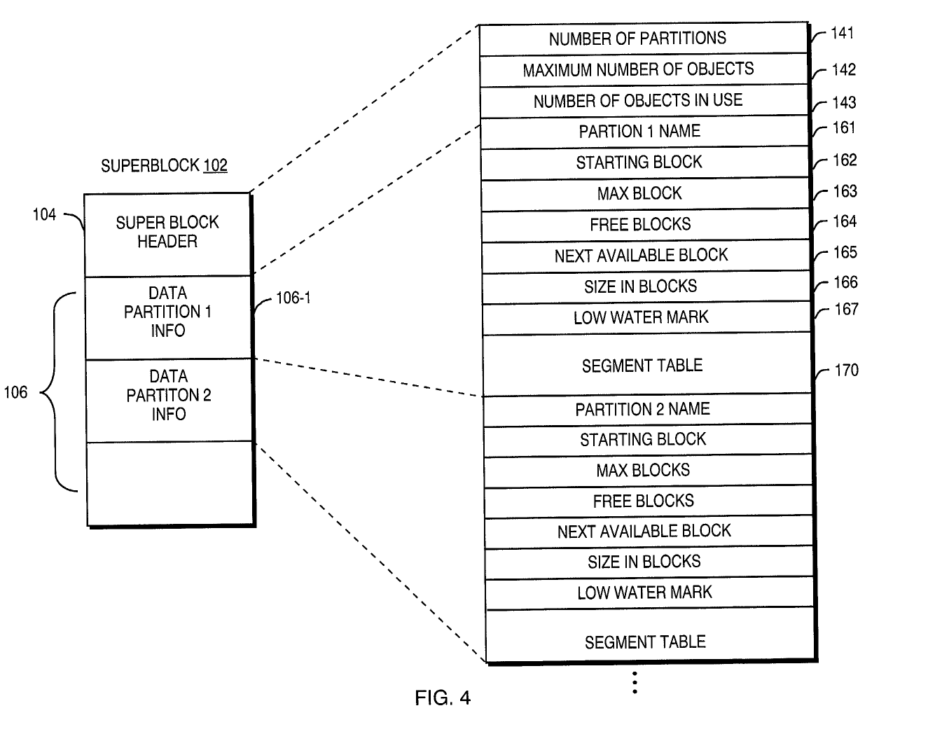

Superblock 102 also holds an array which has one entry per data partition 200. This array describes the state of each data partition 200, for example, the name of the partition, the size of the partition, and other information such as a segment array (shown in FIG. 4). This information pertaining to the state of each data partition may be contained in a per-partition information section 106 of the superblock 102.

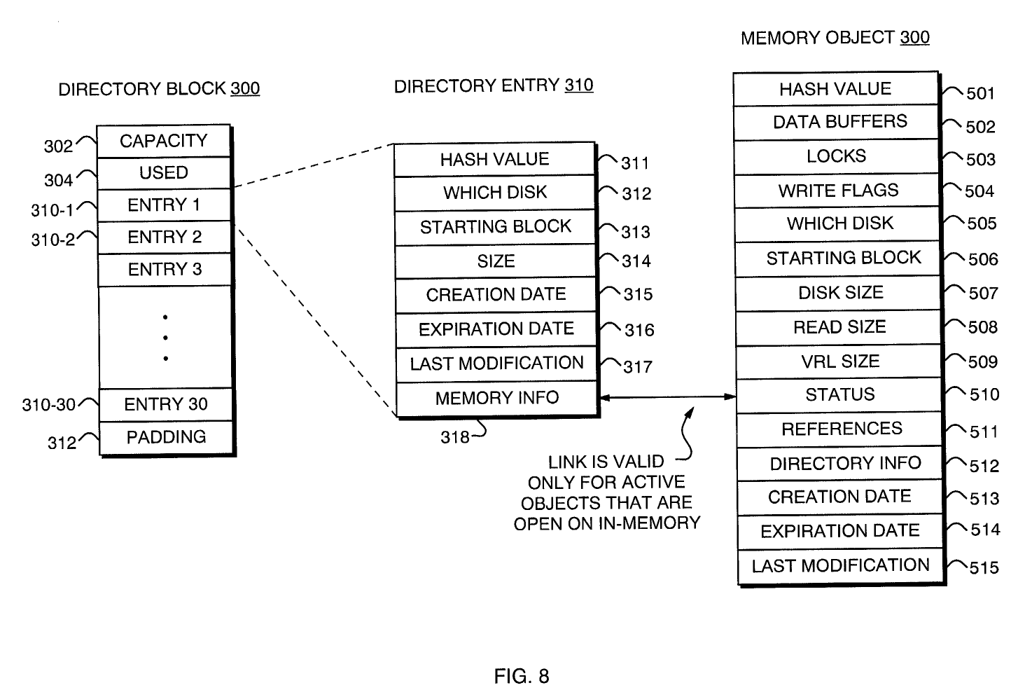

A second portion of the meta data partition 100 contains directory information 120. Directory information 120 may be stored within the meta data partition 100 as a set of directory blocks 300-0, 300-1, . . . , 300-d−1, where d is the total number of directory blocks. The directory information 120 is described in greater detail below in connection with FIG. 8.

FIG. 4 is a more detailed view of a superblock 102. A superblock 102 contains a superblock header 104 and per-partition information 106 as previously described. The header includes per-partition information, for example, object data partition information for each of the data partitions.

The superblock header 104 therefore typically contains data fields indicating a number of partitions 141, a maximum number of objects 142, a number of objects presently in use 143.

An exemplary data partition 160 portion of the superblock 102 contains information such as a partition name 161, starting block number 162, a maximum number of blocks 163, a number of free blocks 164, an index to a next available block 165, its size in blocks 166, and a lower water mark 167, in addition to a segment table 170. The data maintained should include enough information to determine whether each corresponding segment is full, how many objects there are in the segment, a segment flag, and a segment time stamp indicating the last time at which an object was written. The segment information may be kept in the segment tables 170, along with other information, as part of the superblock 102.

It should be understood that a copy of the superblock 100 structure is instantiated in RAM at system startup time when the superblock is read in from the meta data portion 100. The superblock 102 is thus maintained in the main memory of the processor so that it is easily and quickly accessible. The superblock 102 is preferably written back to the disk periodically as part of a flushing back operation.

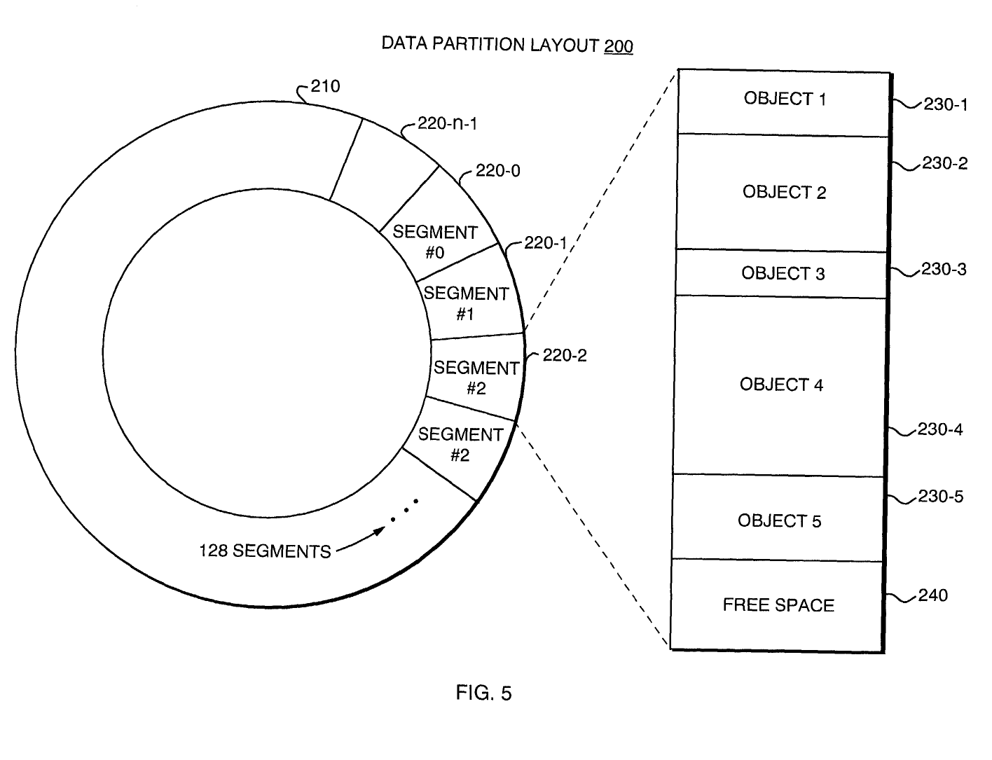

Turning attention briefly to FIG. 5, it is seen at each data partition 200 can be considered to be a type of ring structure. The ring 210 thus can be thought of as consisting of a number of segments 220-0, 220-1, . . . , 220-n−1 where n is the total number of segments. In the indicated preferred embodiment, there are 128 segments as previously described. An exemplary segment, such as the segment 220-2 illustrated, may contain any number of data objects. In the illustrated example, segment 220-2 contains five data objects 230 (labeled object 1, object 2, . . . , object 5). Another portion of the segment 220-2 does not yet contain any objects 230 and therefore can be considered to be free space 240.

It should be understood that each data object 230 is kept whole on its individual partition. For example, any given data object is not permitted to cross boundaries between two object data partitions 200.

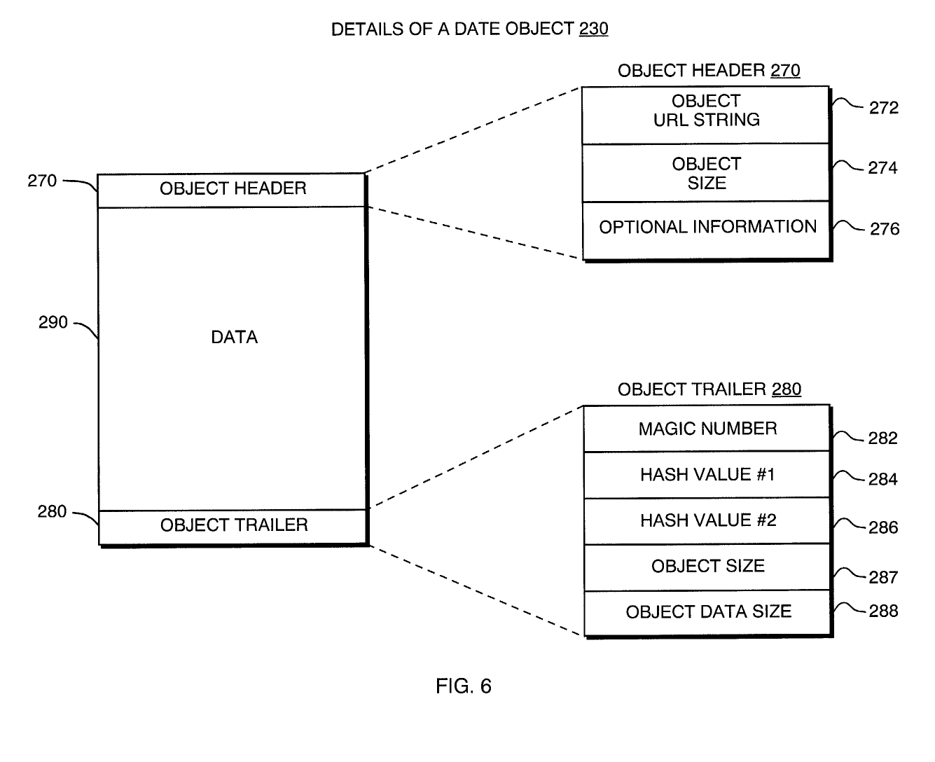

It should also be recognized that the number of active segments, such as one segment 220 per ring 210, are determined and that objects are assigned to active segments in a round-robin fashion. For an empty ring 210, the active segment 220 is the first empty segment in a ring. Once a segment 220 is full, the next empty segment is selected to become an active segment. If no empty segments 220 are found, the ring is full. Whenever data is written into a segment, a segment time stamp may be updated to the present time. For more information in connection with the stores of segments 220 in a partition 200 will be discussed in connection with FIGS. 5 and 6 and others below.

Further details of a data object 230 are shown in FIG. 6. As stored in one of the segments 220, a data object 230 consists of an object header 270, a data portion 290, and an object trailer 280. Other information may also be included in the data object 230.

The object header 270 consists of various fields, including an object URL string 272, an object size 274, and other optional information 276.

The object trailer 280 consists of a magic number 282, a first hash value 284, a second hash value 286, an object size 287, and object data size 288. The magic number 282 is a unique stamp used for validation.

The data portion 290 of the data object 230 contains the actual source object data.

When an object 230 is opened for reading, both the header 270 and trailer 280 are used to validate the object against the directory information. If the object is not validated, it is removed from the directory and the open request will return an error indicating the object is not available. If the object is validated, then read access is granted. Validation protects against unexpected system crashes, as will be better understood below.

In standard file systems such as Unix™, a data object (such as a file) is accessed with a variable length alpha-numeric string that is kept in a hierarchical directory structure, called an index node, or “inode” for short. In the present disk structure, each data object is also referenced by a URL. However, the URLs themselves are not used directly to provide access into a hierarchical directory structure.

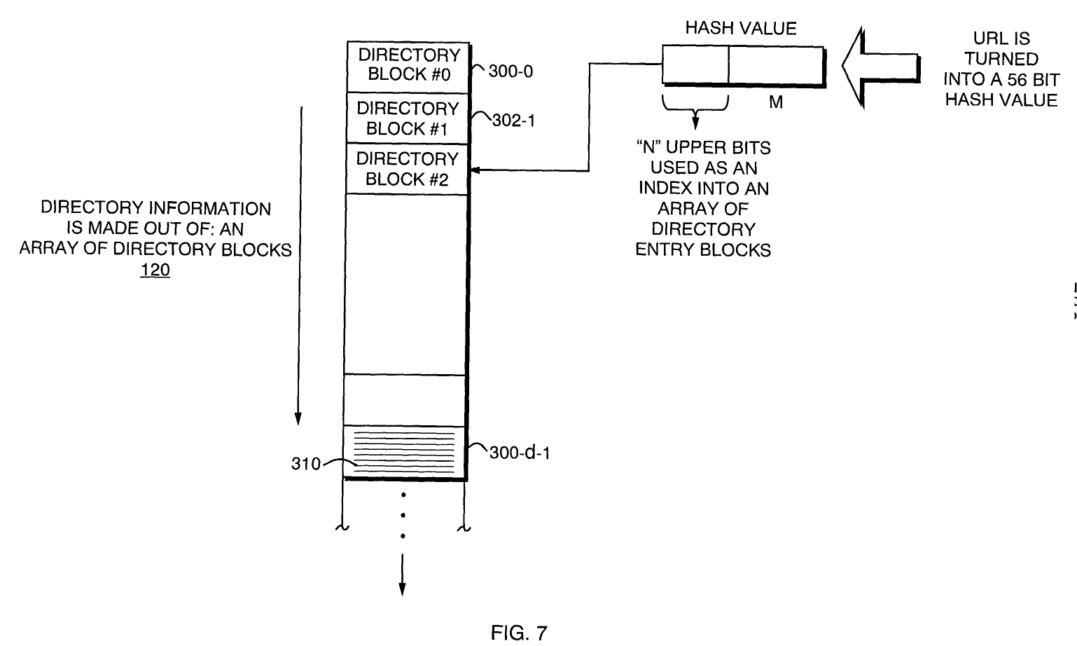

Instead, as shown in FIG. 7, a URL is first turned into a 56 bit value or hashed. This 56 bit hash value may, for example, consist of a pair of values, including an upper value of N bits, and a lower hash value of M bits. Values for N and M are set according to the available system memory. For example, a first system with 100 GB of local disk space could use a configuration that caches up to 8.1 million objects, with N set to 18 and M set to 38. The system could use a configuration with N set to 18 and M set to 39, to support up to 4.1 million objects.

The invention therefore replaces a traditional hierarchical directory structure using the two hash value integers to name each object. A mathematical construct is thus used instead of a traditional hierarchical directory structure to locate an object.

The upper N bits of the hash value are then used to indicate an index into one of the directory blocks 300. There are 2^{N} such directory blocks 300. A directory block 300 may hold a fixed number of entries, for example, 2^{M}, each of which will hold information concerning a single URL object 230.

The lower M bits of hash value are thus used to specify a particular directory entry 310 within a certain directory block 300. Each directory block 300 thus consists of a number of directory entries 310, as determined by the lower hash value M.

### Object Write, Read, and Delete Procedures

A process proceeds in order to store a data object 230 as follows.

1. The object URL is hashed into two numbers of N bits and M bits, respectively.

2. The upper N bits are then indexed to find an appropriate directory block.

3. The directory block 300 is then searched to find an empty directory entry 310. This involves potentially also removing any stale entries from the directory block 300.

4. If an empty directory entry 310 is found, then it is assigned to the new object 230. This involves entering the object name (hash value) into the corresponding directory entry 310.

5. If no empty directory entry 310 is found, then an error indicating such is returned indicating that the object 230 may not be added to the directory due to lack of space.

A process for looking up the location of an existing object 230 and reading its contents proceeds as follows.

1. The object URL is hashed into two numbers of N and M bits.

2. The upper N bits are indexed to find an appropriate directory block 300 number.

3. The directory block 300 is then searched for a matching directory entry 310.

4. Any stale entries are removed.

5. If the requested entry 310 is found, then the appropriate information is returned.

6. If no entry is found, an error is returned indicating that the object does not exist in the directory.

A process for removing or deleting an object 230 may proceed as follows.

1. The object URL is hashed into two numbers.

2. The upper N bits are indexed to find an appropriate directory block 300.

3. The directory block 300 is then searched for a matching directory entry 310 and any stale entries are removed.

4. If the entry is found, then it is freed and made reusable by a new object at a later time.

5. If the entry is not found, an error is returned indicating the object does not exist in the directory and therefore was not deleted.

The directory blocks 300 are preferably kept in one large contiguous portion of local memory such as Random Access Memory (RAM) with a persistent copy kept on a dedicated disk partition such as in the meta data portion 100. At startup time, this region is read from the disk in a large contiguous read operation. This allows the directory information to be brought into local memory rapidly.

Once in memory, the directory information is available without any further disk access time. During a system shutdown process, the directory information 120 may be written back to the disk in one, large raw write operation in a rapid fashion. During operation, the directory information is periodically written back to the disk. This amount of time may be configurable to allow the information to be preserved in case of an unexpected failure. This directory structure thus allows fast object creation, deletion, and lookup without large disk access or memory scans needed to maintain the directory integrity.

FIG. 8 shows the configuration of a directory block 300 in more detail. Each directory block 300 contains a field indicating its capacity 302 and whether or not it is presently in use 304. A number of directory entries 310-1, 310-2, 310-30 then comprise a remainder of the directory block 300. Padding 312 may be optionally added to the directory block for further control.

Each directory entry 310 includes a number of data fields, including a hash value 311, disk number 312, starting block 313, size 314, a creation date 315, expiration date 316, a last modification time stamp 317, and memory information 318.

Returning attention now to FIG. 5, the basic disk structure layout approach will be reviewed. Recall that each individual disk partition is treated as an independent storage unit. The area within each data partition 200 is divided into a fixed number of equal size segments 220, with the number of segments 220 being a configurable value. A storage algorithm keeps track of an active segment 220 for each partition 200.

New objects are stored whole and contiguously into the active segment of a partition 200, with the selected partition 200 picked on a round-robin basis among the available partitions 200-0, 200-1, . . . , 200-p. Once an active segment 220 for a particular partition 210 becomes full, a new empty segment 220 within that partition is assigned to be the active segment.

If no empty segments 220 are available, that partition 200 is declared as full until garbage collection is available to clear out a full segment 220 to market as empty. The garbage collection process is described in further detail below.

The requirement that data objects 230 be written contiguously in each segment in turn dictates that whenever a data object 230 starts to be written, its size must be known. This size is then used to allocate a contiguous number of blocks within that selected active segment 220. This allows the data object 230 to be written in the segment “whole,” without having to break it up into a number of smaller sized blocks, and scatter it all over the disk as in done in traditional file systems such as Unix™ or Microsoft Windows™.

A potential drawback to this approach is that it is difficult to increase the size of an object 230 once written. However, this is not a problem typically for a URL object store, since the stored data objects are hardly ever modified after they have been written. In other instances, even when the objects are overwritten, it is only on a very infrequent basis.

The directory structure provides an additional advantage in that an object 230 may be completely specified with just three values. These include a value indicating the particular data partition 200 in which the object resides, a value indicating the location within the partition such as a segment number 220, and a value indicating the size of the object. Thus, only these three values need to be stored in a directory entry 310 for an object.

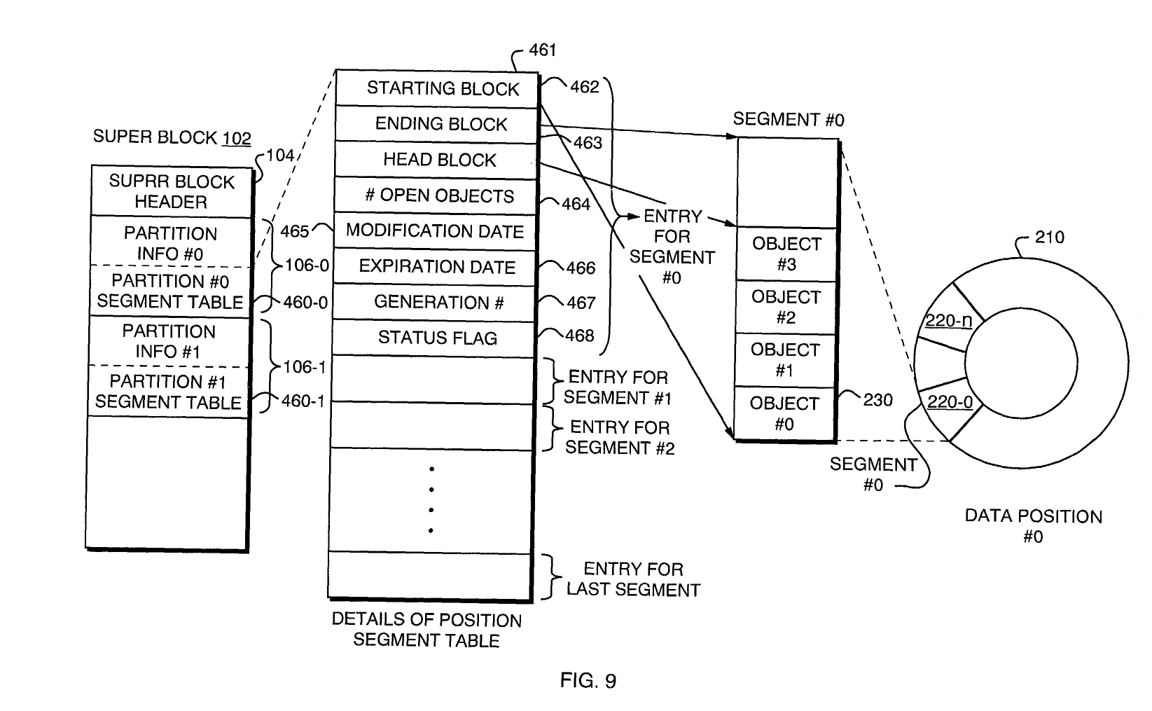

The information regarding segments 220 is kept in a per-ring array of per-segment data 106 that describes the status of each segment 220. The information includes whether a segment is full, how many objects there are in a segment, a segment flag, and a segment time stamp indicating the time at which the last object was written in the corresponding segment 220. This array of information is referred to herein as the segment table 170. This may in turn be stored in the superblock 102 and in particular, in the per-partition information section 106. Referring back to FIG. 4 and also more particularly to FIG. 9, the information block 106 as seen to include a partition segment table 460 associated with the particular partition. The partition segment table may include the information just described, including the starting disk block number 461, ending block 462, header block 463, a number indicating the number of open objects 464, a modification date 465, and expiration date 466, a generation number 467, and a status flag 468. These entries are included for each of the segments 220 within a data partition 200. Similar entries are made for the other segments 220 in a given partition 200.

This segment information is periodically updated at run time, such as when segments 220 become full, or are garbage collected. It is also written back to the meta data partition 100 periodically, such as every two minutes.

The above approach allows most data objects 230 to be read from the disk in a single contiguous operation.

### The Garbage Collection Process

When a data partition 220 becomes full, such as when a number of empty segments 220 drops below a threshold, space will no longer be allocated to the partition 200. At this point, a garbage collection process is invoked.

There may be two modes of garbage collection. A first mode operates based upon the oldest material, attempting to free up the segments 220 holding the oldest data. The other procedure works based upon expired material, and will only free a segment 220 if its corresponding data has already expired. Each case is described in more detail below.

The “oldest data” garbage collection proceeds as follows. An event handler may periodically scan the segment table 460 to find segments 220 holding the oldest data such as, for example, comparing segment time stamp fields 465. That segment is then marked for garbage collection using the status flag field 468.

Once a segment is so-marked for garbage collection, no more objects residing within it may be opened. This can be enforced at object lookup time. However, request to read from already opened objects are allowed to proceed for a given amount of time in order to avoid disruption of in-progress reads. After the above sequence is over, garbage collection can proceed.

An “expired data” garbage collection process is similar to the oldest data method. However, when segments are scanned, the event handler attempts to find a segment whose data has already expired. If one cannot be found available, meaning at all segments 220 hold unexpired data, then the event handler will simply reschedule itself to run when the first segment 220 is due to expire. The time can be determined by the expiration date field 466.

The methods so far handle freeing of partition space, but garbage collection must also free directory entries that point to objects which have been deleted or expired. If not, the subsystem will run out of directory entries. The preferred embodiment uses a lazy evaluation method wherein no scan is done when an object is freed. Rather, a segment generation field 467 is incremented in the active segment table 460. This effectively invalidates all active directory entries that reference the segment undergoing garbage collection. This works because the object lookup code checks the segment generation number 467 contained in each directory entry 310 against the segment generation number in the active segment table. If they do not match, then the lookup fails.

During any such lookup, the subsystem will have to search a directory block, such as determined using the first N bits of the object 230 hash value, in order to find the object 230 in question. As directory entries in that block are examined to see if they match the object being looked at, their segment generation number is checked against that in the corresponding segment table. If the generation numbers do not match, then the directory entry 310 is freed. Since the subsystem 10 has to go through the directory block scan as part of a lookup anyway, the freeing of stale directory entries comes at very little additional expense.

### Object Structure

In the prior art, such as in Unix™ or Windows™ operating systems, file system integrity is maintained typically through two simultaneous operations. The first operation carefully orders the updates to directories, index nodes (inodes), and data blocks at run time. The second procedure is to run a recovery program before the file system is mounted again. The first approach has a cost on performance and the second generates delays at disk startup time. Certain file systems handle the first problem through meta data logging. The price paid is in an extra recovery pass at startup time.

In contrast to these, the present invention eliminates inode structures, and keeps meta data in each data object and the corresponding directory entry. At run time when the object is read, a run time validation routine will ensure object integrity, thus removing the need for either write ordering or pre-startup recovery programs. If a system running according to the present invention were to crash, then either the directory entry was written to the disk while the on-disk object was not or only partially written. In this case, when the object blocking indicated by the directory entry is read, either the object magic number 282 in the trailer will not identify it as a valid object, or the hash values 284, 286 indicating the name will not match. This is a remote chance in that the actual URL is for a different object but just happened to hash to the same value which also happened to be on the same disk block. Here, the directory structure will try to match the URL embedded in the header to the expected URL and catch the mistake.

In a second instance, the URL object was written to the disk while a directory entry 310 was not written. In this case, the object is not accessible due to lack of a directory entry 310. The disk space will simply go to waste until it is garbage collected, but no errors or integrity issues will arise.

### Memory Object Formats

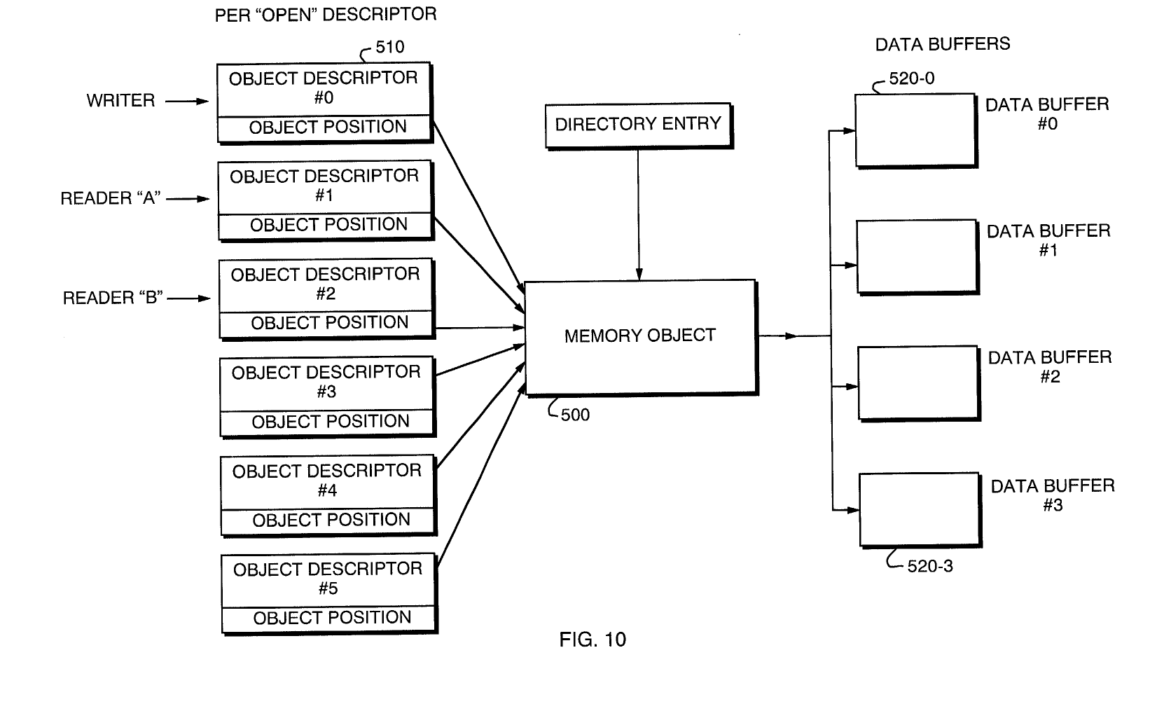

A data object 230 is located and identified by a directory entry 310. When an object is opened for write or read, a structure known as a “memory object” is allocated and the directory entry is made to point to it. Please review FIG. 10 while referring back to FIG. 8. A memory object is created that is shared among all entities that access a given data object 230. Each user will obtain a handle 510 to an open object. The handles 510 to an object 230 may access a create interface (for read or write operations), or an open interface for read operations only.

The handle 510 will point to a single per-object memory object 500. A memory object 500 corresponding to an active object being accessed can contain a corresponding hash value 501, data buffers 502, locks 503, write flags 504, disk identifiers 505, starting block numbers 506, disk size 507, read size 508, write size 509, status information 510, reference information 511, directory information 512, a creation date 513, an expiration date 514, and a time stamp indicating a time last modification 515.

The memory object 500 holds a working set of one or more contiguous buffers 520-0, . . . 520-3 which are used to hold the in-memory version of the on-disk data object 230. The sizes of the buffers 520 for each memory object 500 is the same as the size of the on-disk object up to a configurable maximum. For example, this might be 65 kilobytes. All requests to either read or write objects larger than this maximum buffer size must then, therefore, share buffers for that object.

Read access to an object 230 is suspended for all users except the one who created it until creation is completed and a save interface is invoked. Once an object is fully written with this subsystem, such as indicated by invoking a save interface, the object 230 can be considered to be fully written to the disk. Once the object has been successfully saved, read access can be resumed. An object may only be written once. All attempts to create an existing object and/or write to an object handled obtained via an open interface will be rejected.

An object may be opened for read operations by an open interface. When invoked, the appropriate directory entry is located and the object trailer 280 is read from the disk. The initial validation is performed, and if it passes, a handle 510 is returned. Any object that fits into the working set will then be fully read into memory. This initial read attempt results in a Unix™ server validating the object header. If an object is larger than the working set, then reads which involves areas not in memory, these would result in some of the object memory object buffers becoming recycled and new blocks being read from the disk.

Once all access to an object 230 is complete and all object handles 510 are closed, the object may be placed on a cached list. In order to maximize the number of in-memory cached objects, it is possible to set a configuration value to determine the maximum size of objects that are kept in memory. If this value is not set, the all sized objects will be cached. This value may have a very large impact on the number of objects thus cached. Thus, for example, it is possible to keep 16 times as many 2K objects than 64K objects in memory.

The object may remain cached until there is a shortage of in-memory objects or data buffers. In the former case, the object is purged from the cache and resources reused for new objects. A purged object remains on the disk and becomes available for further access. Access to a purged object, however, will require further disk input/output operations.

### Hash Number Generation

The URL of a requested object is first converted to the form of a binary character string of data that is converted to a substantially unique but reduced set of data bits. Based on this reduced set of data bits, a location of the requested object can therefore be determined for retrieval. The conversion may involve using a mapping technique used in a directory table which includes multiple link lists. Simple, if there are many characters in a particular URL, there are many bytes of information associated with the URL or paths specified. Regardless of its length, this binary number is converted to a reduced fixed set of bits using a mathematic equation such as one based on a logical manipulation of the bits. Accordingly, a file specifier of an unknown length can be hashed to produce a fixed length binary number to map a URL to a corresponding directory table entry.

In a preferred embodiment, the hash value may be based upon a mathematical combination of module operations such as

g(URL)=Σ[u(i)x x(i)]MOD M

where the number, M, equals 2⁵⁶, U(i) represents a component of the URL character string to be hashed, and each x(i) is a unique random number. It should be understood that other hashing functions may be implemented. What is important to recognize is that the object specifier must be hashable to a shortened number using a two-tiered method.

While this invention has been particularly shown and described with references to preferred embodiments thereof, it will be understood by those skilled in the art that various changes in form and details may be made therein without departing from the scope of the invention encompassed by the appended claims.

What is claimed is:

1. A non-hierarchical file subsystem for storing data objects comprising:
a mass storage device allocated by a server to the file subsystem comprising:
multiple object data partitions, the object data partitions for storing data objects within one of a number of variable-length object spaces, with multiple fixed-length segments located within each object data partition; and
at least one meta data disk partition for storing subsystem meta data information, object meta data information, and object directory, the object directory comprising an array of directory blocks each comprising pointers to a particular disk object space within a particular segment of a particular partition, and for retrieving a data object using a hash value of a hierarchical specifier for the data object.

2. A file subsystem as in claim 1 wherein the mass storage device is a disk drive.

3. A file subsystem as in claim 1 wherein the hierarchical specifier for the data object is a Uniform Resource Locator (URL).

4. A file subsystem as in claim 1 wherein the file subsystem is incorporated in one fo a Web page home server or Web page cache server.

5. A file subsystem as in claim 1 wherein the hash value is separated into two hash portions, with a first portion used as an index to select one of a plurality of directory blocks, and a second portion is used to select a directory entry in a directory block.

6. A file subsystem as in claim 5 wherein the directory entry specifies at least a segment, starting block number, and size for the data object.

7. A file subsystem as in claim 1 additionally comprising:
at least one data buffer allocated to the file subsystem for receiving data objects sequentially and for returning data objects sequentially in response to requests for data objects by a hash value representing a hierarchical specifier of a data object, wherein a data object received has a header comprising at least the size and hierarchical specifier of a data object and a trailer comprising at least a two part hash value representing the data object.

8. A file subsystem as in claim 7 additionally comprising:
a data processor coupled to a Random Access Memory (RAM), the RAM holding temporarily a table of meta data and network object data within the data buffer while the processor searches a RAM directory array for a particular block in the array that contains a network address that matches that of the network object and terminates the storage of the network object and upon not finding a network address, storing the network object within the data buffer to the next available object space within the active segment of an active partition and adding the location of the network object to a block within the RAM directory array.

9. A file system as in claim 1 wherein the data objects are stored in the mass storage device such that byte portions of data objects are sequentially stored and such that each data object is only stored in one segment.

10. A file system as in claim 1 wherein a plurality of data objects are stored contiguously in a given segment.

11. A file system as in claim 1 wherein new objects to be stored are stored in a selected segment based upon a round-robin selection scheme.

12. A storage subsystem as in claim 1 wherein a data object is written to overwrite an oldest data object in a segment when a segment is full.
